(19) United States
(12) Patent Application Publication
(10) Pub. No.: US 2021/0316170 A1
(43) Pub. Date: Oct. 14, 2021

(54) REUSABLE FACE MASK

(71) Applicant: Conopco, Inc., d/b/a UNILEVER, Englewood Cliffs, NJ (US)

(72) Inventors: Brett Christopher DOMOY, Basom, NY (US); Gregory LALIER, Brookfield, CT (US)

(73) Assignee: Conopco, Inc., d/b/a UNILEVER, Englewood Cliffs, NJ (US)

(21) Appl. No.: 16/843,446

(22) Filed: Apr. 8, 2020

(51) Int. Cl. A62B 23/02; A41D 13/11

(52) U.S. Cl. CPC A62B 23/025; A41D 13/1138; A41D 13/1169

(57) ABSTRACT

The invention is directed to a reusable face mask that may be fitted with filter material from the inside, outside or both inside and outside of the mask. Any filter material can be used and easily replaced in the face mask which is washable and environmentally sustainable.

### FIELD OF THE INVENTION

The present invention is directed to a reusable face mask. More particularly, the invention is directed to a face mask that comprises a body portion and a filter portion. The body portion has an interior surface forming a cavity which is concave in nature and that fits on and surrounds and covers at least a portion of a user's face and nose, and preferably, the user's entire mouth. The face mask also comprises an outer surface which is convex in nature and the outer surface is suitable to provide the user with some protection from physical trauma. The filter portion is suitable to receive or accept replaceable filter material that protects the user from inhaling unwanted materials that may include biohazards, pollutants, airborne particulates and debris as well as pathogens, including bacteria, viruses or the like. The filter portion of the face mask can receive replaceable filter material from the interior surface or the outer surface of the mask, or both surfaces simultaneously.

### BACKGROUND OF THE INVENTION

Face masks are commonly used to protect doctors, dentists, nurses, patients, other professionals and consumers from a variety of unwanted materials. Medical professionals wear masks to protect patients from contamination like bacteria that often can be expelled from the mouths and/or noses of the professionals while they are talking and caring for patients. Patients that are coughing and sneezing and in need of medical assistance often wear masks to protect those caring for them.

Professional artisans, like carpenters, painters and automobile mechanics often wear face masks. This is true because automobile exhausts, adhesives, insulations, cements, paints or the like can pollute the air with small particle debris, undesirable organic-based aromas or both, all of which are best kept out of the respiratory system. Walkers, fitness enthusiasts and commuters are also avid users of face masks, not only to protect themselves from pollutants and odors but also to prevent the transmission of bacteria and viruses that can cause illness. Unfortunately, many of the face masks used today are single use only and quickly discarded after only a few hours of use.

Face masks are particularly important during national emergencies such as those often caused by a widespread occurrence of disease. Epidemics such as the one caused by ebola and pandemics like those caused by influenza, cholera and HIV/AIDS are often best defeated with regimens that include medical treatment, hand washing, social distancing and the use of face masks. Information provided by the Centers for Disease Control and Prevention suggests that the COVID-19 (coronavirus) pandemic is a direct result of a virus that is more efficient than influenza and that spreads rapidly from person to person via respiratory droplets. Since respiratory droplets can be best contained with the use of face masks, during the COVID-19 pandemic and the Emergency Declaration it resulted in, both professionals and consumers globally had to confront an excessive shortage of face masks. The shortage of face masks inevitably resulted in deaths that could have been prevented.

It is of increasing interest to develop a face mask that can protect both professionals and consumers and be used on more than one occurrence. It is also desirable to develop a face mask that not only can be used more than once, but that also can be quickly cleaned and equipped with a new filter made from any material that allows air to pass through for breathing while simultaneously stopping unwanted materials from getting into the respiratory system of the user. This is especially true during a pandemic.

This invention, therefore, is directed to a face mask that is reusable, fast to clean and easy to equip with new filter material. The face mask comprises a body portion and a filter portion wherein the body portion can be quickly cleaned for reuse and the filter portion is suitable for use with a filter that can be rapidly replaced and made from any material that allows air to pass through while simultaneously stopping unwanted materials that may include biohazards, pollutants, airborne particulates and debris as well as pathogens, including bacteria and viruses or the like. The reusable mask of the present invention is particulary desirable during national emergencies when there can be shortages of masks and such a mask provides an additional benefit in that it is sustainable and not quickly disposed of as environmental waste.

Additional Information

Efforts have been described for making face masks. In U.S. Published Patent Application No. 2016/0317848A1, respiratory masks having dielectrophoretic filters capable of filtering air are disclosed.

Other efforts have been described for making face masks. In U.S. Published Patent Application No. 2007/0295334A1, masks suitable to inhibit the passage of viruses and germs are disclosed.

Even other efforts have been described for making face masks. In U.S. Pat. No. 7,152,600, face masks to protect civilians from biohazards are disclosed.

Still other efforts have been disclosed for making face masks. In U.S. Pat. No. 7,228,858, a face mask incorporated into a protective garment is disclosed.

None of the additional information above describes an environmentally friendly and reusable face mask that is easy to clean and has a filter portion that can receive filter material on its interior or exterior surface, or both.

### SUMMARY OF THE INVENTION

In a first aspect, the present invention is directed to a face mask comprising:
a) a body portion, the body portion having an interior side with an interior surface forming a cavity which is concave and an exterior side having an outer surface which is convex and opposite the interior surface; and
b) a filter portion to accept filter material, the filter portion being centrally located on the face mask and comprising:
   i. a filter portion wall with a perimeter and at least one orifice that allows air to pass through, the filter portion wall having a first side on the interior side of the body portion and a second side on the exterior side of the body portion;
   ii. a filter portion ridge that connects (or joins) the filter portion wall to the mask; and
   iii. a means for holding the mask on to the face of a user,

wherein the filter portion ridge surrounds the perimeter of the filter portion wall and has a width from 0.3 cm to 20 cm (preferably from 0.4 cm to 8 cm, and most preferably, from 0.6 cm to 1.5 cm) and further wherein the filter portion protrudes from the outer surface of the face mask and is recessed on the interior surface of the face mask to accept filter material on the first side of the filter portion wall, on the second side of the filter portion wall or on both sides of the filter portion wall.

In a second embodiment, the present invention is directed to a method of preventing at least one of a biohazard, pollutant, airborne particulate, debris or pathogen from entering the respiratory system of a user with the face mask of the first aspect of the invention.

All other aspects of the present invention will more readily become apparent from the description, figures and example which follow.

User as defined herein means any human being such as a medical professional, a skilled artisan or traditional consumer such as a consumer in a supermarket and even a child or baby. Means for holding a mask on the face of a user is meant to include holding (wearing) the mask on a user's face with single or double-sided tape, adhesive (preferably water-soluble adhesive), a material strip (e.g., string, rope, yarn or twine including floss, tom fabric or a shoe lace, rubber band, elastic strips or straps), a connection to a face shield, but preferably, with material strips that are elastic strips like an elastic strap. Allowing air to pass as used herein means having an open orifice. Concave in nature as used herein means to bevel inward and convex in nature as used herein means to bevel outward. Contaminant as used herein means at least one of a biohazard, pollutant (including volatiles like high VOC organics and aromas), airborne particulates, debris, pathogens or a combination thereof. Filter material (also commonly called a respirator or respirator material) as used herein means any material that when placed (i.e., received, accepted, inserted or attached) on a mask that surrounds a user's mouth and nostrils allows for air to pass and normal breathing (i.e., breathing without exertion, without resistance and hyperventilating) while at the same time preventing at least one contaminant from entering the respiratory system of the user (i.e., having a collection or filtration efficiency of greater than zero). Protection from physical trauma means able to deflect even a slight force or blow to protect a user such as a force initiated by a falling twig. Accept (or receive) filter material as used herein means attached or combined with the filter portion and removable, where for the avoidance of doubt, the filter portion is a portion of the reusable face mask. Centrally located means when the face mask is worn by a user, both the user's nose and mouth can inhale and exhale through the filter portion. Sealed application means filter material received or accepted by the filter portion and not allowing air to enter the face mask through the filter portion without first passing through the filter material were the filter material preferably does come in contact with the filter portion wall (on the internal and external side of the mask) when received or accepted by the filter portion. Collection or filtration efficiency means the percent of airborne contaminant having a particle size from 0.1 to 0.3 micron in size that is blocked by the filter material, as defined by the National Institute for Occupational Safety and Health Administration.

### BRIEF DESCRIPTION OF THE DRAWINGS

The subject matter which is regarded as the invention is particularly pointed out and distinctly claimed in the concluding portion of the specification. The invention, however, may be best understood by reference to the following description taken in conjunction with the accompanying drawing figures in which:

FIG. 1 is a perspective view of the face mask where the means for holding the mask on a user's face is illustrated with a material strip;

FIG. 2 is a front view of the face mask with the filter portion illustrated as circular in shape;

FIG. 3 depicts the left side view of the face mask wherein the right-side view is a mirror image thereof;

FIGS. 4a and 4b depict the top and bottom views of the face mask, respectively;

FIG. 5 depicts a view showing the concave interior side and interior surface of the face mask and where the filter portion is recessed and suitable for insertion of a first filter material holder;

FIG. 6 depicts first filter material holder having filter material surrounding the outside diameter thereof;

FIG. 7 depicts a view showing the convex exterior side and outer surface of the face mask having the filter portion protrude for attachment of a second filter material holder; and

FIG. 8 depicts a view of second filter material holder having filter material inserted within the inside diameter thereof.

### DETAILED DESCRIPTION OF THE INVENTION

The face mask of the present invention is reusable, washable and easily refitted with new filter material. The only limitations with respect to material used to make the body portion of the face mask of the invention is that the same is solid, can provide minimal protection from physical trauma and can be reused and washed with soap and water. In an embodiment of the invention, the face mask is made of a material that is dishwasher safe, wash machine safe and/or suitable for sterilization in a conventional hospital autoclave that uses pressurized steam at a temperature from 110 to 125° C. In another embodiment of the invention, the material used to make the body portion of the face mask is at least 90%, and preferably at least 95%, and most preferably, 100/a non-porous to contaminants. Illustrative examples of the types of materials suitable to make the body portion of the face mask of the present invention include polyethylene (including high density polyethylene, i.e., density of 0.96 or higher), polypropylene, polyethylene terephthalate, polycarbonate, polyester (including co-polyesters), urethane and polyurethane. Other materials suitable for use include polyvinyl chloride, polyphenylene oxide, acrylonitrile butadiene styrene, polyamides as well as copolymers and blends of such materials. It is particularly noted that the mask of the present invention may be recycled and made from materials that are or include post-consumer recycled plastics. The thickness of the face mask and the molecular weight of the material used to make the face mask are selected to ensure that the when the mask is held on (applied or worn) on the face of the user, the face mask is pliable to adjust to the contour of the user's face (to essentially seal the face mask to the user's face) when the means for holding the mask to the user's face are used. Typically, the face mask has a thickness from 0.05 mm to 1 mm, and preferably, from 0.1 mm to 0.8 mm, and preferably, from 0.15 mm to 0.65 mm, including all ranges subsumed therein. When plastic is used to make the face mask of the present invention, the molecular weight (number average MWₙ) of the material used is typically from 75,000 to 500,000, and preferably, from 125,000 to 400,000, and most preferably, from 165,000 to 300,000 g/mol, including all ranges subsumed therein.

Regarding the tooling and methods used to make the face mask of the present invention, conventional art recognized techniques and equipment may be employed. Such techniques include blow molding (including extrusion blow molding), injection molding, cast molding, compression molding methods as well as thermoforming where plastic is heated and applied onto or into a mold. Another technique suitable for use to make the face mask of the present invention is additive manufacturing. In an embodiment of the invention, the face mask is made via conventional extrusion blow molding techniques and the material used is at least 85% by weight, and preferably, at least 95% by weight, and most preferably, at least 98% by weight polypropylene. In still another embodiment of the invention, the material used to make the mask of the present invention is 100% by weight polypropylene.

The filter material used with the mask of the present invention is limited only to the extent that it can stop a contaminant, is air permeable and allows for normal breathing. Such material can be a tissue, a napkin, a paper towel, a coffee filter, a portion of a rag, towel, shirt, tie, pants, scarf, sheet or even a pillow case. The material can also be a handkerchief, portion of a curtain, blanket, jacket, hat, sweater, sock or even a portion of a table cloth or furniture upholstery. Still further, filter material suitable for use with the face mask of the present invention may be a portion of material removed from a surgical gown, surgical mask, hospital scrubs or even a diaper. Therefore, the filter material suitable for use with the mask of the present invention is not required to be made specifically for the face mask of the invention, it can take on a variety of shapes and may be torn or cut by a user from any material that may be received or accepted (i.e., inserted in or attached on) by the filter portion of the face mask, especially if the user of the face mask is confronting an emergency or crisis such as one caused in a hospital, for example, by an epidemic and/or pandemic. The filter material can, therefore, originate from garments made from traditional sources like cotton, polyester, nylon, cellulosic fiber, wool, silk or blends thereof.

In an embodiment of the invention (and especially when the user is not confronting an emergency or crisis), the filter material can be precut, typically store purchased and made and packaged specifically for the face mask of the invention. The shape of the precut or purchased filter material is not critical so long as the dimensions allow for a sealed application (attachment or insertion) of filter material on the filter portion of the face mask. As to the filter material suitable for use with the face mask of the present invention, when purchased and made specifically for the face mask of this invention, the same is often a combination of materials that may include wool, cotton, plastic, glass, charcoal, cellulose, polyester, polyamide or the like. Such filter material can be a single or multilayer material, and optionally, made to mimic the texture, feel and thickness of surgical masks typically found in a hospital. When purchased, the collection or filtration efficacy of the filter material should exceed 50%, and preferably, exceed 75%, and most preferably, be at 95% or higher and thus have an N95 rating. Optionally, purchased filter material may be electrostatically charged, coated with antimicrobial materials like surfactants, or both.

The filter material suitable for use in the present invention will typically have a thickness from 0.8 mm to 1.25 cm, and preferably, from 0.1 mm to 0.85 cm, and preferably, from 0.2 mm to 0.65 cm, including all ranges subsumed therein. As to the pore size of the filter material suitable for use in this invention, typically the pore size is from 0.2 to 20 microns, and preferably, from 0.3 to 10 microns, and most preferably, from 0.8 to 5 microns, including all ranges subsumed therein. In another embodiment of the invention, the filter material has a pore size from 0.5 to 1.5 microns, including all ranges subsumed therein.

The reusable face mask of the present invention is superior to what is conventionally made and available. The mask can quickly be cleaned with soap and water and can be equipped with any filter material that is air permeable and suitable to block a contaminant. What will further be emphasized from the figures in conjunction with the description that follows are the facts that filter material used in the present invention may be replaced, easily, quickly, by anyone including the user and when the user is physically wearing the mask, making the mask of this invention very desirable for use in emergency and crisis situations like epidemics and pandemics. The mask of the present invention is particularly desirable for use in hospital emergency rooms, especially during a public health emergency declaration.

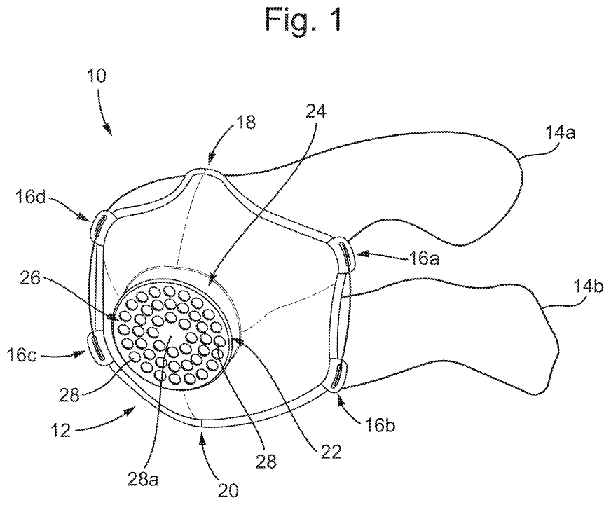

Turning to the figures, FIG. 1 shows a perspective view of the reusable face mask 10. The face mask has a body portion 12, which may be made in many different sizes to appropriately fit a user (e.g., adult or child), and is pliable when held or worn on a user's face, not shown. In an illustrative embodiment, the face mask 10 as depicted in FIG. 1 is held on to a user's face by a means for holding the mask on a face represented as material strips 14a and 14b connected to the face mask body 12 at face mask connector loops 16a, 16b, 16c and 16d that are generally positioned opposite each other and at the corners of the face mask 10. While it is true that material strips 14a and 14b may be positioned anywhere on a user's head or neck, not shown, to seal the body portion 12 to the user's face, in a preferred embodiment strip 14a should be positioned generally at and around the neck or lower portion of the head of the user and strip 14b should be positioned generally at and around the upper portion of the user's head. As previously indicated, such strips, 14a and 14b, may be made from any material suitable to hold the mask 10 on the face of a user. Moreover, the strips 14a and 14b may be tied, buckled, stapled, weaved or clipped onto connector loops 16a, 16b, 16c, and 16d, and a suitable but less desirable option is for face mask 10 to have only a single strip, not shown, having one end attached to the right side of the face mask 10 and the opposite end attached to the to the left side of the face mask 10. When only one strip is used, only two face mask connector loops are required or preferred, one on the right side of the face mask 10 and the other on the left side of the face mask 10 where both are placed near the middle of each side. In another embodiment, not shown and for example, material strip 14a can have one end connected to connector loop 16a and the opposite end connected to connector loop 16b while material strip 14b can have one end connected to connector loop 16c and the opposite end connected to connector loop 16d so that material strips 14a and 14b can be place around the user's ears in lieu of the user's head and/or neck.

Face mask body 12 has a nose elevation 18 to cover at least a portion of a user's nose and a rounded chin portion 20 to cover the user's chin when the face mask 10 is worn. Filter portion 22, depicted as circular but can be any desired shape, is centrally located on the body portion 12. The filter portion 22 has a filter portion ridge 24 that surrounds the perimeter of the filter portion wall 26. The filter portion 22 of the face mask 10, typically makes up from to 15% to 45%, and preferably, from 15% to 35%, and most preferably, from 18% to 30% of the area of the face mask 10, including all ranges subsumed therein. Filter portion wall 26 is illustrated with a plurality of orifices 28 optionally shown as organized circles of equal diameters surrounding a generally central and large orifice 28a having a diameter that is from 2 to 5, and preferably, from 2 to 4, and most preferably, from 2 to 3 times the diameter of each of the orifices 28. It is within the scope of the invention for such orifices 28 to be of any shape and size as is the case for the large orifice 28a which is not required but preferred in order to enhance air flow through the face mask 10 and via the filter portion wall 26. In an embodiment of the invention, the area of the plurality of orifices 28 plus the area of the large orifice 28a (i.e., orifice area) is from 35 to 95%, and preferably, from 40 to 90%, and most preferably, from 45 to 85% of the area of the filter portion wall, including all ranges subsumed therein.

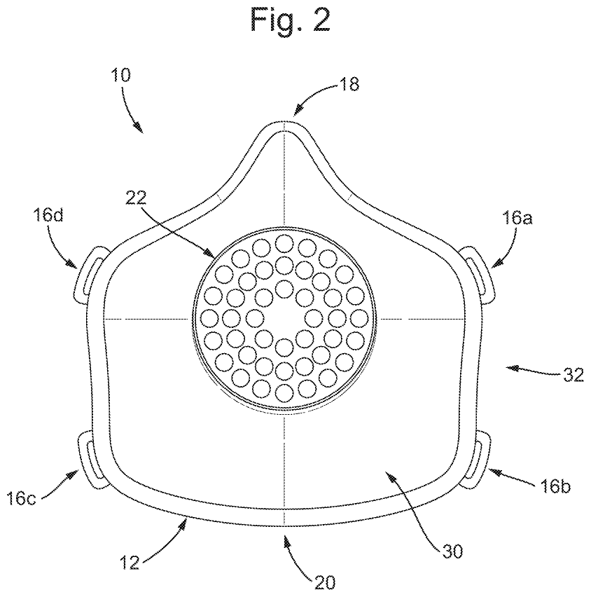

Turning to FIG. 2, shown is a front view of the face mask 10 of the present invention. The filter portion 22 is shown making up from 15 to 45% of the area of the outer surface 30 on the exterior side 32 of the body portion 12 of the face mask 10. Face mask connector loops 16a, 16b, 16c and 16d are depicted as loops extending from the face mask 10, and such loops can in the alternative can be holes (e.g., small orifices), not shown, in the body portion 12 and generally in the corners of the face mask 10 to receive material strips as shown in FIG. 1 as 14a and 14b. Nose elevation 18 and rounded chin portion 20 are shown and designed to protect the user and to yield user comfort when the mask is used and worn.

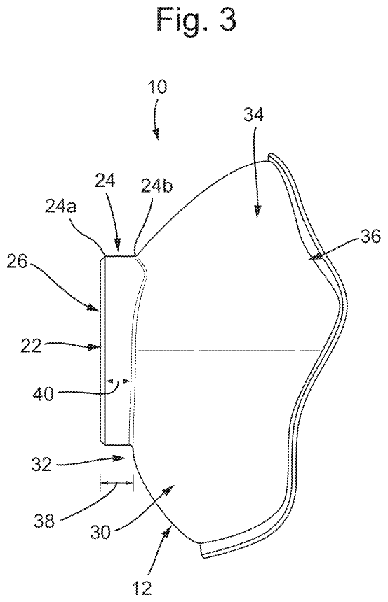

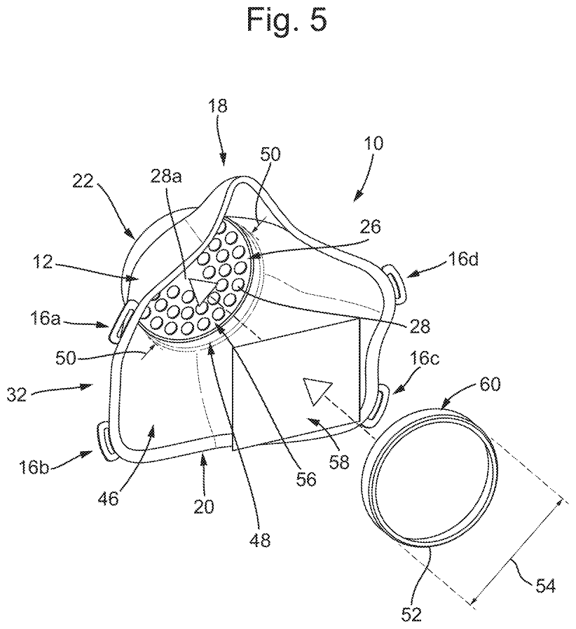

FIG. 3 shows a left side view of the face mask 10, the right-side view, not shown, being a mirror image thereof. Seen is the body portion 12 having an outer surface 30 which is convex on the exterior side 32 of the face mask 10. Side portion 34 of the body portion 12 terminates with a side contoured edge 36 for comfortable placement of the face mask 10 on the face of a user. Filter portion 22 is shown with filter portion wall 26 surrounded by filter portion ridge 24. Filter portion wall 26 (which has a first interior side and a second exterior side) is shown and illustrated at the anterior end 24a of the filter portion ridge 24 but it is within the scope of the invention for the filter portion wall 26 to be positioned closer to the posterior end 24b of the filter portion ridge 24 so long as the positioning of the filter portion wall 26 does not eliminate a recessed portion of the filter portion 22 on the interior surface of the face mask 10 (as shown and later depicted in FIG. 5). Filter portion 22 is shown protruding a protrusion distance 38 from body portion 12 where the protrusion distance is equal to the general width 40 of the filter portion ridge 24.

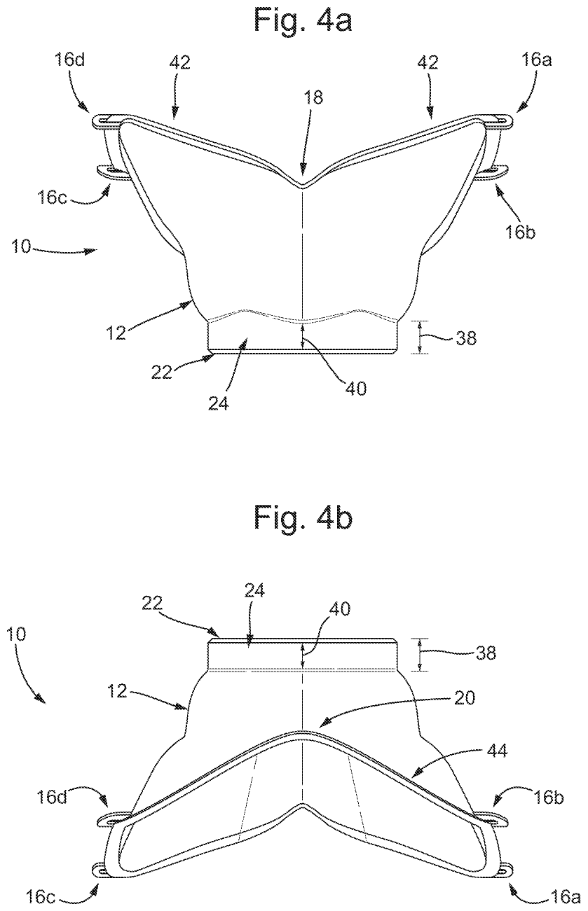

Turning to FIG. 4a, shown is a top view of the face mask 10 having a nose elevation 18 and top contoured edge 42 with previously illustrated connector loops 16a, 16b, 16c and 16d for receiving material strips, not shown. Filter portion 22 is shown protruding a protrusion distance 38 from body portion 12 where the protrusion distance is equal to the general width 40 of the filter portion ridge 24.

Turning to FIG. 4b, shown is a bottom view of the face mask 10 having the rounded chin portion 20 and bottom contoured edge 44 with illustrated connector loops 16a, 16b, 16c and 16d for receiving material strips, not shown. Filter portion 22 is again shown protruding a protrusion distance 38 from body portion 12 where the protrusion distance 38 is equal to the general width 40 of the filter portion ridge 24.

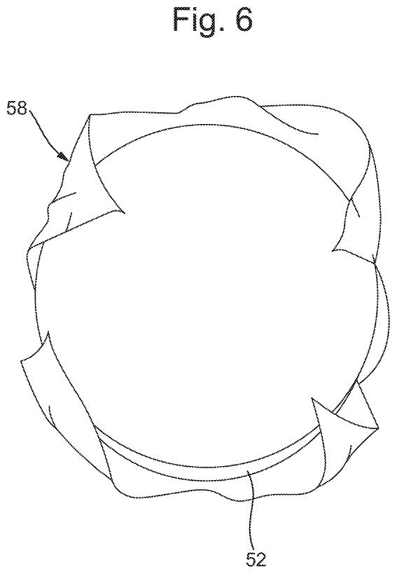

In FIG. 5, illustrated is the face mask 10 having a concave interior side 46, a nose elevation 18 with rounded chin portion 20, both of which are part of the body portion 12 of the face mask 10. Also shown are connector loops 16a, 16b, 16c, and 16d for receiving material strips, not shown. Filter portion 22 is shown protruding from body portion 12 of the face mask 10 on the exterior side 32. From the interior side 46 of the face mask 10, the filter portion wall 26 is shown with an illustrative plurality of orifices 28 again shown as organized circles of equal diameters surrounding a generally central and large orifice 28a (optional). Filter portion 22 from interior side 46 of the face mask 10 has a recessed ledge 48 that surrounds the perimeter of the of the filter portion wall 26 from the interior side 46. The recessed ledge 48 forms an inside dimension (for circles often referred to as an inside diameter) 50 which is of a size that allows for first material filter holder 52 having an outside diameter 54 to fit within the recessed void 56 created by the recessed ledge 48 (often the recessed ledge is from 0.6 to 5 cm, and preferably, from 1 to 2 cm, and most preferably from 1.1 to 1.6 cm in width). Such a fit is one which is tight, and therefore, the first material filter holder 52 needs to be pushed into the recessed void 56 with some force. The first filter holder 52, therefore, will be held into the recessed void 56 with friction (or the first filter holder 52 and the recessed void 56 may optionally be threaded, externally and internally, respectively) making the first filter holder 52 easy to insert and remove while at the same time locking the first filter holder 52 in place during ordinary use. As may be readily gleaned from FIG. 5 in conjunction with FIG. 6, first filter holder 52 is pressed against filter material 58 such that filter material 58 is pressed over the external portion 60 (i.e., outside diameter and sides) of the first filter holder 52 for insertion into the recessed void 56 to thereby hold filter material 58 in place, and preferably, against the first and internal surface of the filter portion wall 26 that faces out from the concave interior side 46 of the face mask 10. Thus, the exterior (caused by the outside diameter of first filter holder 52) presses against the recessed ledge 48 that forms the recessed void 56 (outside diameter in conjunction with inside diameter to hold filter material in place).

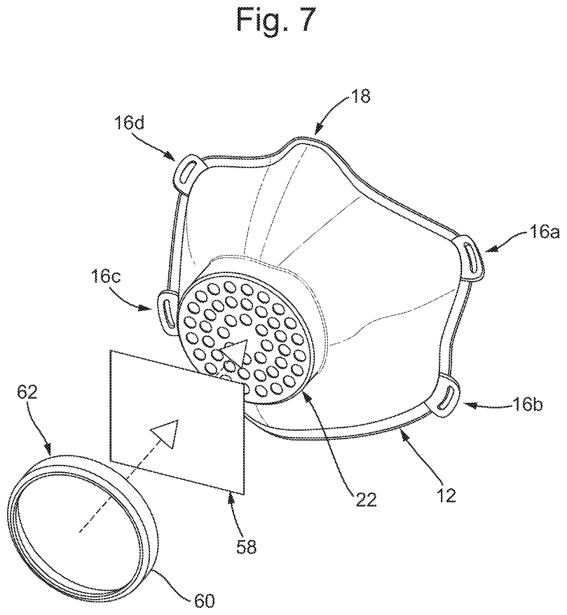

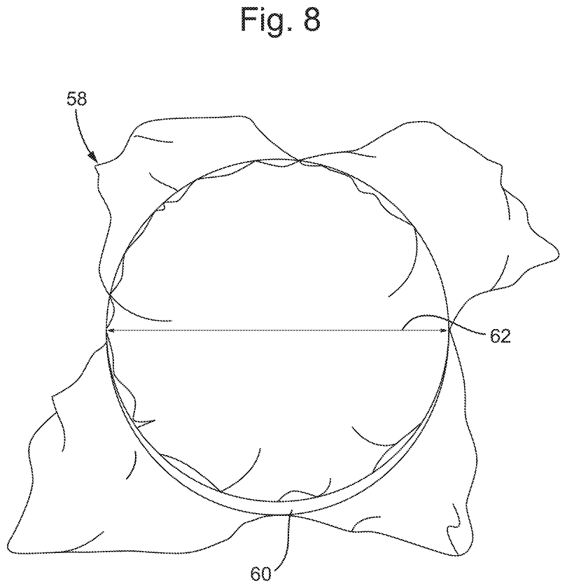

Turning to FIG. 7, shown is the face mask 10 of the present invention with connector loops 16a, 16b 16c and 16d. Also illustrated on face mask 10 is nose elevation 18 and filter portion 22 protruding from body portion 12 of the face mask 10. Second filter holder 60 has an inside diameter 62 that fits tightly over filter portion ridge 24 of filter portion 22. As may be readily gleaned from FIG. 7 in conjunction with FIG. 8, second filter holder 60 internally receives filter material 58 for insertion over filter portion ridge 24 to secure filter material 58 preferably against filter portion wall 26 (at its second and exterior surface) that faces out from the exterior side 32 which is convex in nature.

Like the first filter material holder 52, the second filter material holder 60 is pressed over the filter portion ridge 24 and held place with friction (or the second filter holder 60 and the filter portion ridge 24 may optionally be threaded, internally and externally, respectively). For the avoidance of doubt, the amount of friction is enough such that the second filter material holder may be easily pressed on and pulled off but not fall off during ordinary use (inside diameter in conjunction with outside diameter to hold filter material in place).

The mask of the present invention is superior in that filter material may be replaced on the inside, outside or both sides of the mask in under a minute, even seconds. The mask is reusable, washable, recyclable and suitable to prevent mask shortages during an emergency crisis. Moreover, the size of the filter material used is limited only to the extent that it does not interfere with the ordinary use of the mask and covers the orifices within the filter portion wall of the filter portion. Of course, if very thin or thicker filter material is used, the inside diameter and outside diameter of the first and second filter material holders need to be adjusted. Therefore, the mask of the present invention may be supplied with holders of a variety of sizes. In an emergency, for example, glue, string, clamps, tape, and/or even a rubber band can be a quick substitute for filter material holders. Typically, first filter material holder 52 and second filter material holder 60 are extruded plastic like the plastic used to make the face mask 10. In an embodiment of the invention and not shown, filter material holders may be provided that have 2 outside and 2 inside diameters. Therefore, two identical holders may be sold with the mask and merely flipped if the interior and exterior sides of the filter portion are not manufactured to use the exact same filter holder.

Of course, the mask of the present invention can include any art recognized branding, decorating, embossing, colors and emblems desired by users. Conventional snaps, clips, buckles and the like may be used if desired, especially with the material strips described herein.

The Example is provided to facilitate an understanding of the present invention. The example is not intended to limit the scope of the invention as set forth in the claims.

### Example

The reusable face mask 10 of the present invention was manufactured by art recognized ejection blow molding as were the filter material holders it was provided with. A panelist in a mock emergency grabbed the mask of the present invention and napkins (as filter material) that were located nearby. The panelist fitted both on the interior and exterior of the mask with the napkins at the filter portion with the filter material holders provided. The napkins were set in place (in under a minute) and the mask was placed on the user's face with material strips made from elastic. The user was able to breathe without exertion and would have been protected from contaminant had the mock emergency been real. The napkin or filter material on the outside of the mask was subsequently replaced by the user within seconds and while the user was still wearing the mask.

What is claimed is:

1. A face mask comprising:
a) a body portion, the body portion having an interior side with an interior surface forming a cavity which is concave and an exterior side having an outer surface which is convex and opposite the interior surface; and
b) a filter portion to accept filter material, the filter portion being centrally located on the face mask and comprising:
i. a filter portion wall with a perimeter and at least one orifice that allows air to pass through, the filter portion wall having a first side on the interior side of the body portion and a second side on the exterior side of the body portion;
ii. a filter portion ridge that connects the filter portion wall to the mask; and
iii. a means for holding the mask on to the face of a user,
wherein the filter portion ridge surrounds the perimeter of the filter portion wall and has a width from 0.3 cm to 20 cm and further wherein the filter portion protrudes from the outer surface of the face mask and is recessed on the interior surface of the face mask to accept filter material on the first side of the filter portion wall, on the second side of the filter portion wall or on both sides of the filter portion wall.

2. The face mask according to claim 1 wherein the mask is reusable and washable with soap and water.

3. The face mask according to claim 1 wherein the filter material comprises tissue, napkin, paper towel, coffee filter, a portion of a rag, towel, shirt, tie, pants, scarf, sheet, pillow case, handkerchief, curtain, blanket, jacket, hat, sweater, sock, table cloth or furniture upholstery.

4. The face mask according to claim 1 wherein the filter material comprises surgical gown, surgical mask, hospital scrubs or diaper.

5. The face mask according to claim 1 wherein the filter material is purchased respirator for face masks comprising wool, cotton, plastic, glass, charcoal, cellulose, polyester, polyamide or a combination thereof.

6. The face mask according to claim 1 wherein the mask is held on a face of a user with single or double-sided tape, adhesive, rubber band or a material strip.

7. The facemask according to claim 6 wherein the material strip is string, rope, yarn, twine, floss, torn fabric, shoe lace, rubber band, elastic strip or a straps.

8. The face mask according to claim 1 wherein the face mask stops a contaminant from entering a user's respiratory system.

9. The mask according to claim 8 wherein the contaminant is a biohazard, pollutant, airborne particulate, debris, bacteria, virus or a mixture thereof.

10. The mask according to claim 9 wherein the virus is influenza or a coronavirus.

11. The mask according to claim 1 wherein a first filter material holder interior to the mask has an outside diameter that holds filter material to the mask and a second filter material holder exterior to the mask has an inside diameter that holds filter material to the mask.
The mask according to claim 1 wherein internal and external filter material is replaceable in under 1 minute.

12. A method for preventing a contaminant from entering a user's respiratory system comprising the steps of:
a. placing filter material on the inside, outside or both sides of the face mask of claim; and
b. wearing the face mask while breathing,
wherein the face mask is reusable and washable with soap and water.
